(19) United States
(12) Patent Application Publication
(10) Pub. No.: US 2018/0304505 A1
(43) Pub. Date: Oct. 25, 2018

(54) MANUFACTURING METHOD OF LAMINATED CORE AND CULL PLATE

(71) Applicant: MITSUI HIGH-TEC, INC., Kitakyushu-shi (JP)

(72) Inventor: Hisatomo ISHIMATSU, Fukuoka (JP)

(73) Assignee: MITSUI HIGH-TEC, INC., Kitakyushu-shi (JP)

(21) Appl. No.: 15/950,469

(22) Filed: Apr. 11, 2018

(30) Foreign Application Priority Data
Apr. 24, 2017 (JP) 2017-085227

(51) Int. Cl. B29C 45/14; H01F 41/02; H01F 27/24; B29C 45/40

(52) U.S. Cl. CPC B29C 45/14344; H01F 41/0206; B29K 2995/0008; B29C 45/40; H01F 27/24

(57) ABSTRACT

A manufacturing method of a laminated core includes holding a laminated core body mounted on a cull plate, injecting a resin to a magnet-insert hole from a resin reservoir part provided in a lower die through the cull plate, then ejecting the laminated core body and the cull plate and separating the cull plate from the laminated core body. The cull plate includes a through hole which forms at least a part of a flow path extended from the resin reservoir part to an upper surface of the cull plate. The through hole of the cull plate includes a tapered portion and a straight pipe portion being adjacent to the tapered portion. The tapered portion has an inner diameter gradually decreasing toward the upper surface of the cull plate, and the straight pipe portion has a constant inner diameter in a height direction.

### CROSS REFERENCE TO RELATED APPLICATION(S)

This application is based upon and claims the benefit of priority of Japanese Patent Application No. 2017-85227 filed on Apr. 24, 2017, the contents of which are incorporated herein by reference in its entirety.

### BACKGROUND OF THE INVENTION

### 1. Field of the Invention

The present invention relates to a manufacturing method of a laminated core and a cull plate which is used in the manufacturing method.

### 2. Description of the Related Art

There is known a manufacturing method of a laminated core in which a plurality of magnet-insert holes are provided in the laminated core body, a resin is injected into the magnet-insert holes and solidified after permanent magnets are inserted to the magnet-insert holes, and the permanent magnets are fixed to the laminated core body. In this manufacturing method, the laminated core body with the permanent magnet inserted in the magnet-insert hole is held between an upper die and a lower die, and the resin is injected into the magnet-insert hole from a resin reservoir part which is provided in the upper die or the lower die. The laminated core body is formed by laminating iron core pieces which are formed by punching an electromagnetic steel sheet.

However, when a die comes into direct contact with the laminated core body and the filling of the resin is performed, the resin solidified in the surface of the laminated core body (that is, resin dregs) is left. Therefore, there is a need to perform a process of removing the resin dregs after filling with the resin. Accordingly, an efficiency of manufacturing the laminated core is degraded. In order to solve the problem, there is known a method of interposing a cull plate between the die and the laminated core body to prevent the resin dregs from being attached.

JP-A-2012-165574 as Patent Literature 1 discloses a resin filling device in which a cull plate is held between a lower die and a laminated core, and a magnet-insert hole of the laminated core is filled with a resin from a resin reservoir part of the lower die through the cull plate (FIG. 1). In JP-A-2012-165574, a member corresponding to the cull plate is called a gate plate. In JP-A-2012-165574, there is a description about that the gate plate is usable as a carrying pallet (Paragraph [0039]). In other words, the laminated core is carried to the resin filling device in a state of being mounted on the gate plate. The laminated core is carried out of the resin filling device in a state of being mounted on the gate plate.

A discharge port is disposed in the gate plate to face an opening of a magnet-insert hole of the laminated core. The discharge port passes through from the lower surface to the upper surface of the gate plate, and is formed such that the inner diameter becomes small as it goes from the lower surface to the upper surface (Paragraph [0021], FIG. 4). In other words, the discharge port is tapered at the upper end to make the inner diameter small. Therefore, when the gate plate is separated from the laminated core after filling with the resin, stress is focused on the resin in the upper end of the discharge port, and the resin is broken. As a result, the resin solidified in the magnet-insert hole of the laminated core and the resin left and solidified in the discharge port are separated (Paragraph [0034]). The separation from the laminated core of the gate plate is performed after the gate plate and the laminated core are carried out of the resin filling device (Paragraph [0038]).
Patent Literature 1: JP-A-2012-165574

### SUMMARY OF THE INVENTION

As described above, in the manufacturing method of the laminated core disclosed in JP-A-2012-165574, the laminated core is carried out of the resin filling device in a state of being mounted on the cull plate (gate plate). The separation from the laminated core of the cull plate (gate plate) is performed outside the resin filling device.

However, in the manufacturing method of the laminated core disclosed in JP-A-2012-165574, the laminated core and the cull plate are carried out of the resin filling device after the resin is sufficiently solidified. Therefore, the resin left in the discharge port of the cull plate may be peeled off from the resin filling the magnet-insert hole at an unintended timing. For example, when the laminated core and the cull plate are still in the resin filling device, the resin left in the discharge port is peeled off from the resin filling the magnet-insert hole, and further separated from the cull plate to fall into the lower die.

When the resin left in the discharge port falls into the lower die, manpower and time are required to remove the fallen resin. Therefore, a productivity of the laminated core is reduced. If the laminated core is maintained to be manufactured while overlooking that the resin falls down into the lower die, the quality of products is degraded, or there is a possibility to cause a failure of the resin filling device. In this way, according to the manufacturing method of the laminated core in the related art, the resin left in the discharge port is separated from the cull plate and falls down at an unintended timing. As a result, the productivity is reduced, the quality of products is degraded, or there is a possibility to cause a failure of the device.

The present invention has been made in view of the problems, and an object thereof is to provide a manufacturing method of a laminated core in which a magnet-insert hole of a laminated core body is filled with a resin through a cull plate in order to prevent the resin left in the cull plate after filling with the resin from falling from the cull plate. Another object is to provide a cull plate which is used in the manufacturing method.

An aspect of the present invention provides a manufacturing method of a laminated core, including: holding a laminated core body mounted on a cull plate between an upper die and a lower die which are provided in a resin filling device; injecting a resin to a magnet-insert hole of the laminated core body from a resin reservoir part provided in the lower die through the cull plate; then ejecting the laminated core body and the cull plate from the resin filling device; and separating the cull plate from the laminated core body, wherein the cull plate includes a through hole which forms at least a part of a flow path extended from the resin reservoir part to an upper surface of the cull plate, and the through hole of the cull plate includes a tapered portion and a straight pipe portion being adjacent to the tapered portion, wherein the tapered portion has an inner diameter gradually decreasing toward the upper surface of the cull plate, and the straight pipe portion has a constant inner diameter in a height direction.

Another aspect of the present invention provides a cull plate which is held between a laminated core body and a lower die of a resin filling device in a process where the laminated core body with a permanent magnet inserted into a magnet-insert hole is held between an upper die and the lower die of the resin filling device to inject a resin from a resin reservoir part of the lower die to the magnet-insert hole, the cull plate including: a through hole which forms at least a part of a flow path extended from the resin reservoir part to an upper surface of the cull plate, wherein the through hole includes a tapered portion and a straight pipe portion being adjacent to the tapered portion, wherein the tapered portion has an inner diameter gradually decreasing toward the upper surface of the cull plate, and the straight pipe portion has a constant inner diameter in a height direction.

A part of a through hole of a cull plate according to the aspect of the present invention is formed in a tapered shape, and the other part continued to the tapered part is formed in a straight pipe shape. Therefore, even in a case where the resin left in the through hole is separated from the resin filled in the magnet-insert hole, the resin left in the through hole is held in the through hole by a friction force from the inner wall of the through hole in the part forming the straight pipe shape of the through hole. As a result, the chance of the falling of the resin left in the through hole is decreased. Since the chance of the falling of the resin is decreased, a lowering in a productivity of a laminated core, a lowering in the quality of products, or a failure of a device of manufacturing the laminated core, which are caused by the falling of the resin in a resin filling device, are avoided. As a result, the productivity and the quality of the laminated core are improved, and manufacturing costs are reduced.

### BRIEF DESCRIPTION OF THE DRAWINGS

In the accompanying drawings:

FIGS. 1A and 1B illustrate outlines of a cull plate which is used in a manufacturing method of a laminated core according to an embodiment of the present invention, wherein FIG. 1A is a top view of the cull plate and FIG. 1B is a side view of the cull plate;

FIGS. 2A to 2C are enlarged views illustrating a shape of a gate hole of the cull plate illustrated in FIGS. 1A and 1B, wherein FIG. 2A is a top view of the gate hole, FIG. 2B is a cross-sectional view taken along line P-P′ in FIG. 2A, and FIG. 2C is an enlarged view illustrating part of the cross-sectional view of FIG. 2B on a magnified scale;

FIGS. 3A to 3D illustrate a manufacturing method of the laminated core according to the embodiment of the present invention in a time sequential manner, wherein FIG. 3A is a view illustrating a state where a laminated core body is mounted on the cull plate, FIG. 3B is a view illustrating a state where the laminated core body and the cull plate are attached to a resin filling device, FIG. 3C is a view illustrating a state where the laminated core body and the cull plate are separated from an upper die and a lower die after a magnet-insert hole of the laminated core body is filled with a resin, and FIG. 3D is a view illustrating a state where the cull plate is separated from the laminated core body after the laminated core body and the cull plate are ejected from the resin filling device;

FIGS. 4A and 4B illustrate a method of removing a cull from the cull plate, wherein FIG. 4A is a view illustrating a state where an extrusion tool is placed in the upper surface of the cull plate, and FIG. 4B is a view illustrating a state where the extrusion tool is pressed down to pull the cull out of the cull plate;

FIGS. 5A and 5B illustrate effects achieved by the shape of the gate hole of the cull plate, wherein FIG. 5A is a view illustrating a state before cracks are generated between the resin filled in the magnet-insert hole and the cull left in the gate hole, and FIG. 5B is a view illustrating a state after cracks are generated between the resin and the cull and the resin and the cull are separated;

FIGS. 6A and 6B are cross-sectional views illustrating the shapes of the gate holes according to first and second modifications of the embodiment of the present invention, respectively;

FIG. 7 is a cross-sectional view of the cull plate provided with a blind hole and the laminated core body according to a third modification of the embodiment of the present invention;

FIGS. 8A and 8B illustrate a fourth modification of the embodiment of the present invention, wherein FIG. 8A is a view illustrating two plate members which are overlapped in a vertical direction, and FIG. 8B is a cross-sectional view illustrating part of the cull plate in a magnified scale; and

FIGS. 9A and 9B illustrate the shapes of the gate holes of the cull plate which is used for a comparison test between the present invention and the related art, wherein FIG. 9A is a cross-sectional view illustrating the shape of the gate hole according to a fifth modification of the embodiment of the present invention, and FIG. 9B is a cross-sectional view illustrating the shape of the gate hole according to the related art.

### DETAILED DESCRIPTION OF THE EXEMPLARY EMBODIMENTS

### Embodiment

Hereinafter, a specific embodiment of the present invention will be appropriately described with reference to the drawings.

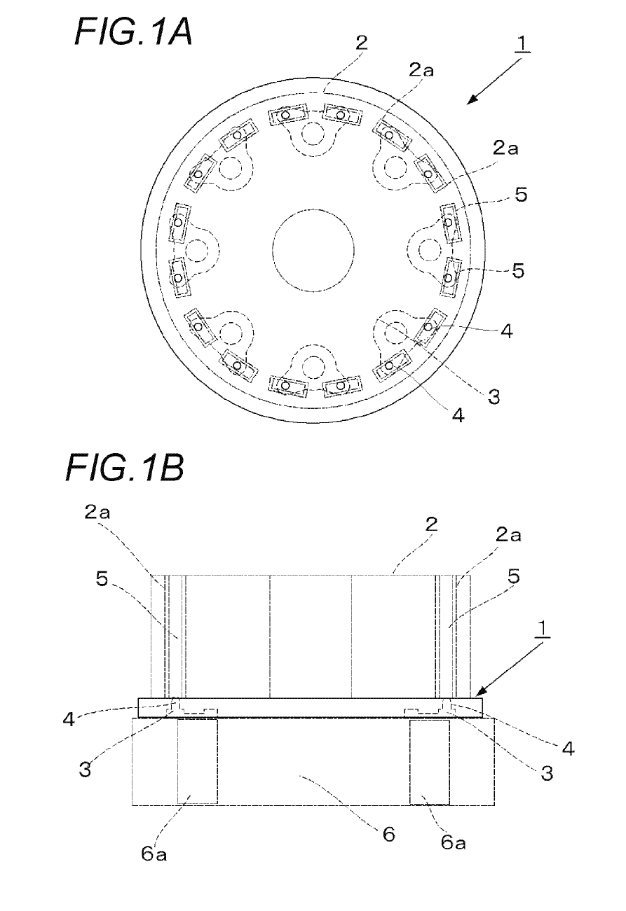

FIGS. 1A and 1B illustrate an outline of a cull plate 1 which is used in a manufacturing method of a laminated core according to an embodiment of the present invention. FIG. 1A is a top view of the cull plate 1. FIG. 1B is a side view of the cull plate 1.

The cull plate 1 is also used as a carrying tool which carries a laminated core body 2. The laminated core body 2 is mounted on the cull plate 1, and carried between processes. As illustrated in FIG. 1A, eight resin injection paths 3 are annularly disposed in the cull plate 1. Each of the resin injection paths 3 includes two gate holes 4. In other words, sixteen gate holes 4 are formed in the cull plate 1. The gate holes 4 are disposed to be overlapped with sixteen magnet-insert holes 2a formed in the laminated core body 2 in top view (that is, FIG. 1A). A permanent magnet 5 is inserted to the magnet-insert hole 2a.

The resin injection path 3 is used to inject a resin from a resin filling device 6 to the magnet-insert hole 2a of the laminated core body 2. In other words, the resin filled in the magnet-insert hole 2a using the resin filling device 6 is guided to the magnet-insert hole 2a through the resin injection path 3.

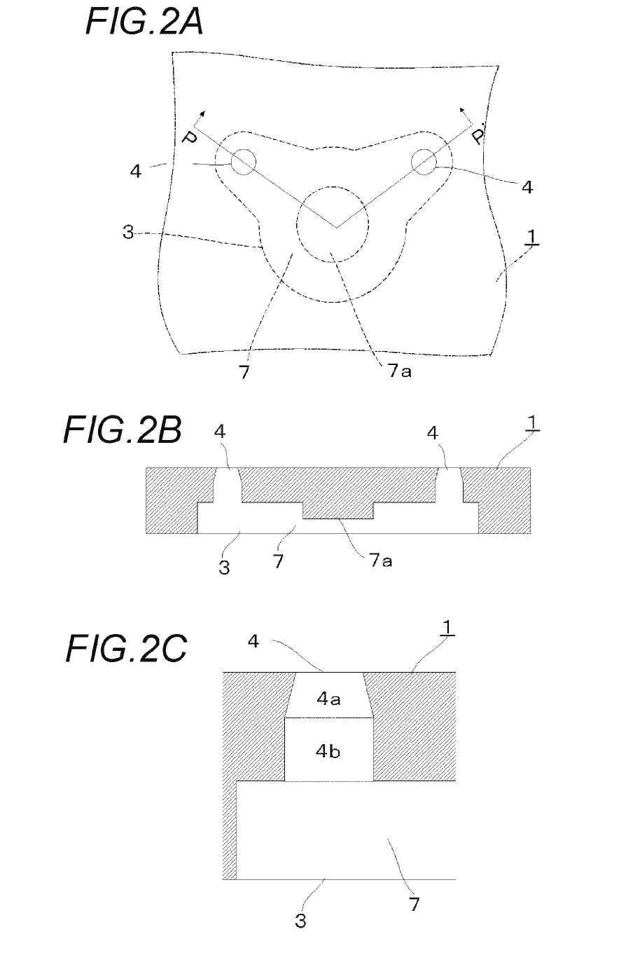

FIGS. 2A to 2C are enlarged views illustrating the shape of the resin injection path 3. FIG. 2A is a top view of the resin injection path 3. FIG. 2B is a cross-sectional view illustrating the resin injection path 3 taken along line P-P′ in FIG. 2A. FIG. 2C is a cross-sectional view illustrating the cross section of the resin injection path 3 illustrated in FIG. 2B in a magnified scale. As illustrated in FIGS. 2A and 2B, the resin injection path 3 includes a runner 7 which opens toward the lower surface of the cull plate 1, and the gate hole 4 which opens toward the upper surface of the cull plate 1. The runner 7 is disposed to face a discharge port of a resin reservoir 6a (not illustrated in FIGS. 2A to 2C) which is provided in the resin filling device 6 (not illustrated in FIGS. 2A to 2C). The gate hole 4 is disposed such that the upper end of the gate hole 4 faces the magnet-insert hole 2a (not illustrated in FIGS. 2A to 2C) of the laminated core body 2. The resin stored in the resin reservoir 6a is pressed by a plunger (not illustrated) to flow into the runner 7. The resin flowed in the runner 7 is discharged into the magnet-insert hole 2a through the gate hole 4. In this way, the gate hole 4 forms part of the resin injection path 3. In other words, the gate hole 4 forms part of the flow path from the resin reservoir 6a of the resin filling device 6 to the upper surface of the cull plate 1. The gate hole 4 opens toward the upper surface of the cull plate 1. A convex portion 7a is formed in a portion facing the resin reservoir 6a of the front surface of the base of the runner 7.

As illustrated in FIGS. 2B and 2C, an upper portion 4a of the gate hole 4 is formed in a tapered shape of which the inner diameter is reduced as it closes to the upper surface of the cull plate 1. A lower portion 4b of the gate hole 4 is formed in almost a straight pipe shape of which the inner diameter is maintained constant in the height direction. The upper portion 4a and the lower portion 4b are continuously formed. The operational effects achieved by the shape of the gate hole 4 will be described below.

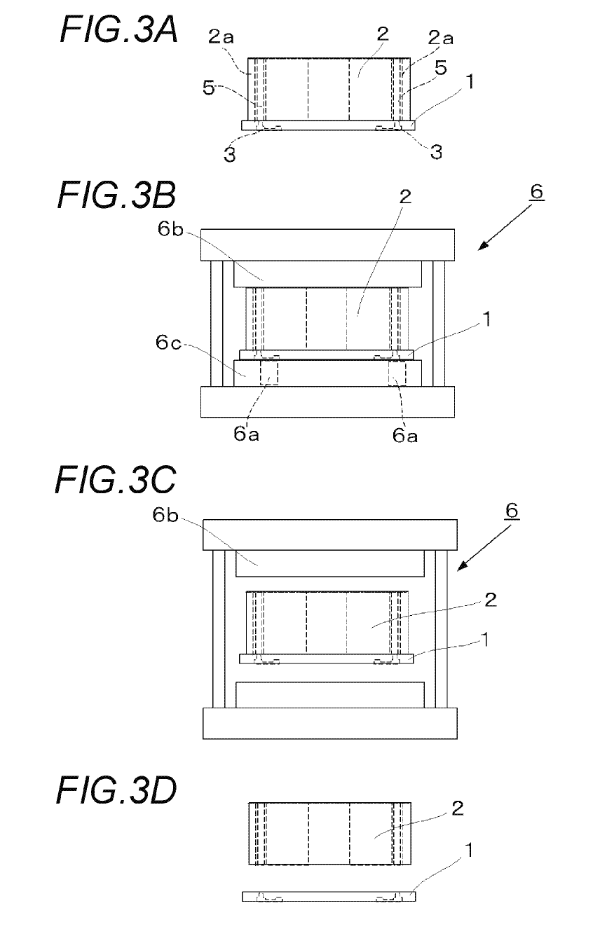

Next, a manufacturing method of the laminated core according to the embodiment will be described in a time sequential manner with reference to FIGS. 3A to 3D. In the manufacturing method of the laminated core according to the embodiment, the laminated core body 2 is first mounted on the cull plate 1 as illustrated in FIG. 3A. The permanent magnet 5 is inserted to the magnet-insert hole 2a which is formed in the laminated core body 2 in the previous process (not illustrated). The laminated core body 2 is manufactured by stacking iron core pieces which are formed by punching an electromagnetic steel sheet in the previous process (not illustrated). Next, as illustrated in FIG. 3B, the laminated core body 2 and the cull plate 1 are placed between an upper die 6b and a lower die 6c of the resin filling device 6. The laminated core body 2 and the cull plate 1 are held and pressed by the upper die 6b and the lower die 6c. The lower die 6c of the resin filling device 6 is provided with the resin reservoir 6a and a plunger (not illustrated). Therefore, the resin stored in the resin reservoir 6a is extruded by the plunger. The resin pressed by the plunger flows into the magnet-insert hole 2a through the resin injection path 3. The magnet-insert hole 2a is filled with the resin. After the resin completely fills the magnet-insert hole 2a, the upper die 6b is pulled up to be separated from the laminated core body 2 as illustrated in FIG. 3C. The laminated core body 2 and the cull plate 1 are pulled up to be separated from the lower die 6c. The laminated core body 2 and the cull plate 1 are ejected from the resin filling device 6. Thereafter, the cull plate 1 is separated from the laminated core body 2 as illustrated in FIG. 3D. Finally, the resin solidified in the resin injection path 3 of the cull plate 1 is ejected. The resin solidified in the resin injection path 3 is called a cull or a resin waste. The cull is discarded.

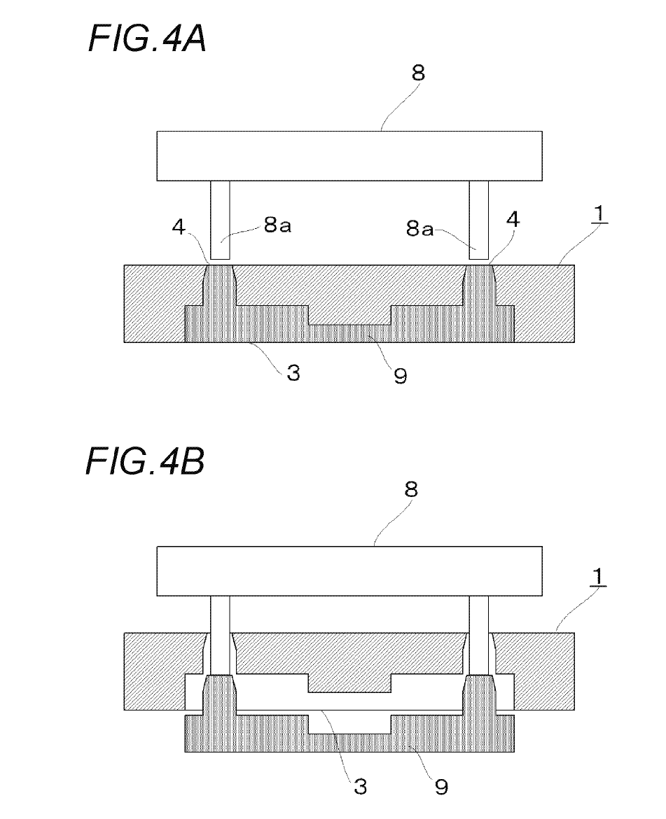

The ejecting of the cull from the cull plate 1 is performed using an extrusion tool 8 as illustrated in FIGS. 4A and 4B. The extrusion tool 8 is provided with an extrusion pin 8a. As illustrated in FIG. 4A, the extrusion pin 8a is placed to abut on the end surface of a cull 9 in the upper surface of the cull plate 1 when viewed from the gate hole 4. When the extrusion tool 8 is pressed down, the cull 9 is extruded from the lower surface of the cull plate 1, and falls to the lower side of the cull plate 1 as illustrated in FIG. 4B.

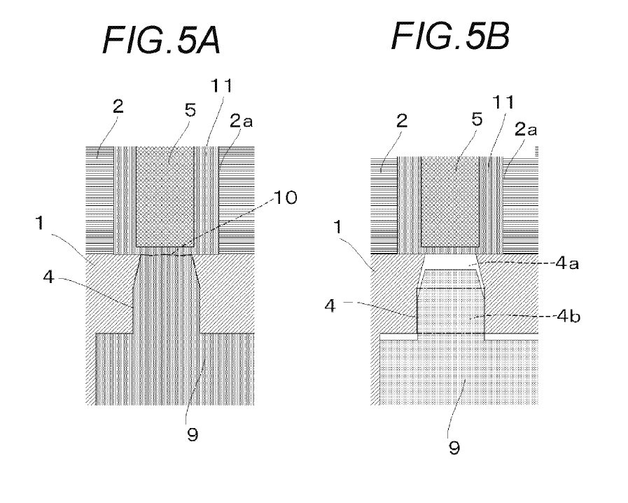

The operational effects achieved by the shape of the gate hole 4 will be described. Herein, it is assumed that cracks 10 are generated in the resin in the upper end surface of the gate hole 4 as illustrated in FIG. 5A before the cull plate 1 is separated from the laminated core body 2. In other words, it is assumed that the cracks 10 are generated between a resin 11 filled in the magnet-insert hole 2a and the cull 9 left in the resin injection path 3. When the cracks 10 are generated between the resin 11 and the cull 9, a tension force applied from the resin 11 to the cull 9 (that is, a force lifting up the cull 9) disappears. When the tension force disappears, the cull 9 is shrank in the gate hole 4 and displaced to the lower side. As a result, as illustrated in FIG. 5A, the cull 9 of the tapered shape of the upper portion 4a of the gate hole 4 does not come into contact with the inner surface of the gate hole 4. However, even in a case where the cull 9 is shrank to the lower side, the cull 9 and the inner surface of the gate hole 4 come into contact with each other in a portion of the straight pipe shape of the lower portion 4b of the gate hole 4. The cull 9 is prevented from falling down by a friction force applied on the cull 9 in the portion.

In this way, according to the cull plate 1 of the embodiment, the cull 9 is prevented from falling down at an unintended timing (for example, a timing illustrated in FIG. 3C). In other words, the cull 9 is prevented from falling down toward the lower die 6c of the resin filling device 6.

First and Second Modifications

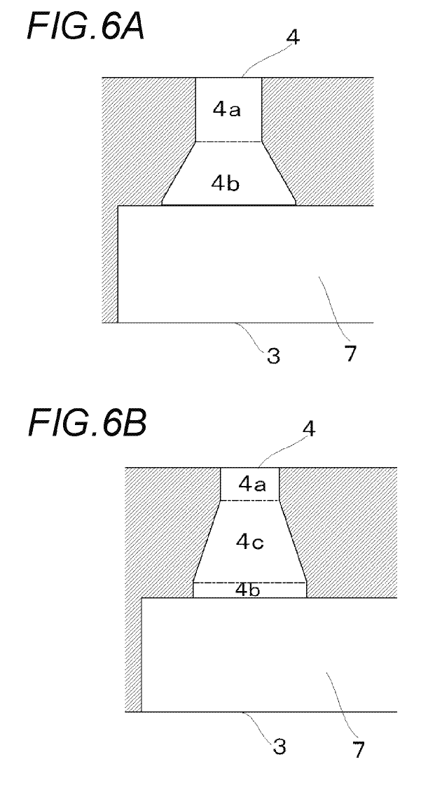

The shape of the gate hole 4 is not limited to that described in the above embodiment (that is, the upper portion 4a is made in the tapered shape, and the lower portion 4b is formed in the straight pipe shape). As illustrated in FIG. 6A, the gate hole 4 may be configured such that the upper portion 4a is made in the straight pipe shape, and the lower portion 4b is formed in the tapered shape. Alternatively, as illustrated in FIG. 6B, the gate hole 4 may be configured such that the upper portion 4a is made in the straight pipe shape, an intermediate part 4c is made in the tapered shape, and the lower portion 4b is made in the straight pipe shape.

Third Modification

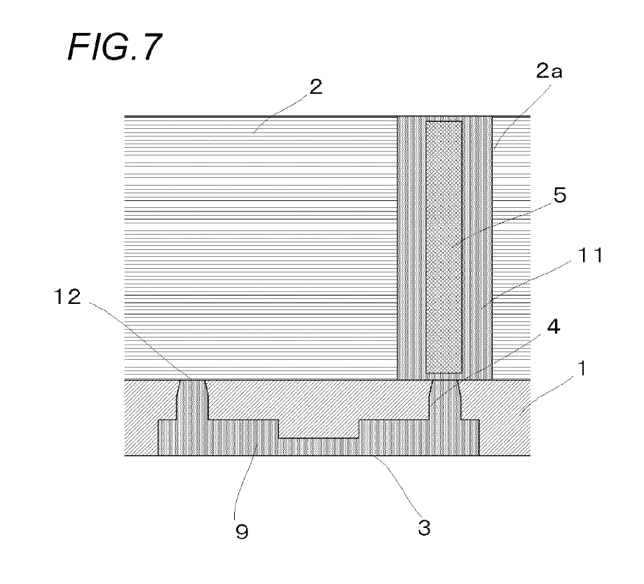

In the above embodiment and the modifications, a portion formed in the tapered shape and a portion formed in the straight pipe shape are provided, and the gate hole 4 has been exemplified as a specific example of a through hole to prevent the cull 9 from falling down. However, the through hole is not limited to the gate hole 4. The through hole may be a blind hole 12 which is not connected to the magnet-insert hole 2a of the laminated core body 2 illustrated in FIG. 7. Similarly to the gate hole 4, the blind hole 12 is used when the cull 9 is ejected using the extrusion tool 8 illustrated in FIGS. 4A and 4B.

Fourth Modification

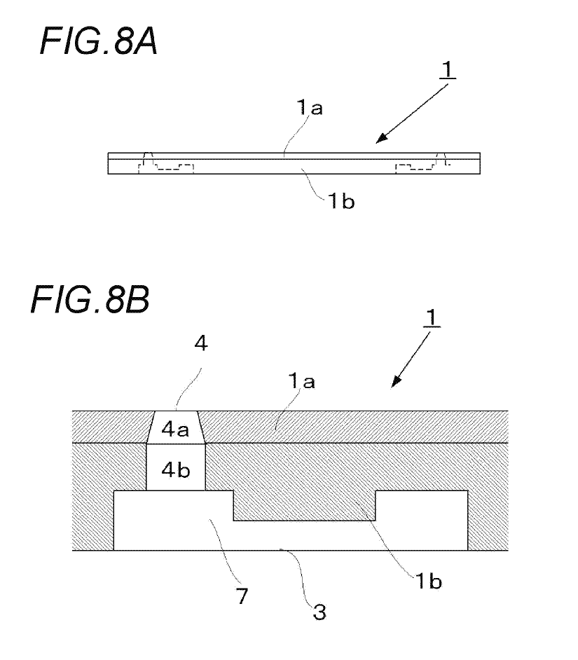

In the above embodiment and the modifications, the cull plate 1 has been exemplified as a single plate member. However, the cull plate 1 is not limited to the above configuration. As illustrated in FIG. 8A, the cull plate 1 may be formed by overlapping an upper plate 1a and a lower plate 1b. As illustrated in FIG. 8B, the upper plate 1a is a plate member which forms the upper portion 4a of the gate hole 4 (that is, a portion forming the tapered shape). The lower plate 1b is a plate member which forms the lower portion 4b of the gate hole 4 (that is, a portion forming the straight pipe shape). In other words, the gate hole 4 which is provided with the portion forming the tapered shape and the portion forming the straight shape is formed by overlapping the upper plate 1a and the lower plate 1b.

Comparison to the Related Art

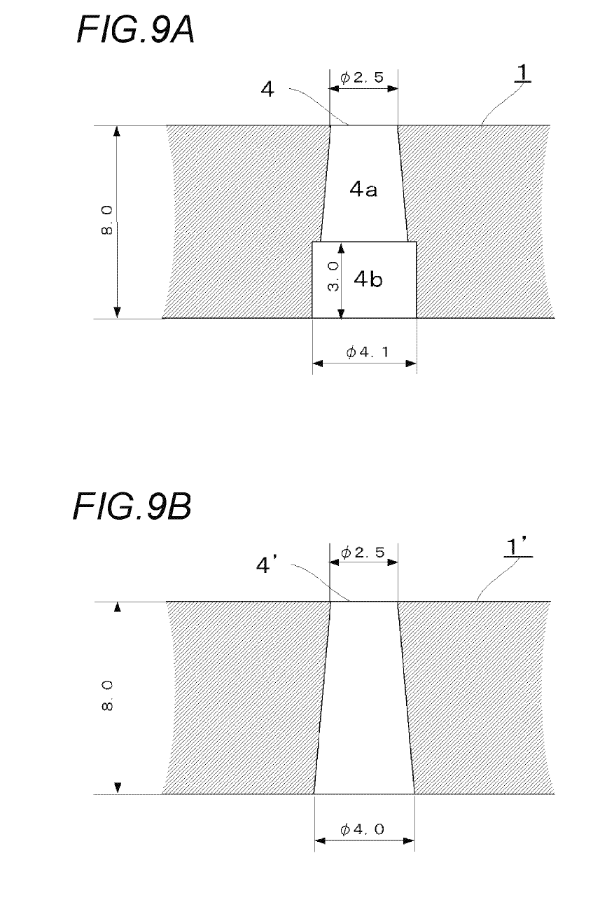

FIG. 9A is a cross-sectional view illustrating a shape of the gate hole 4 which is provided in the resin injection path 3 (not illustrated) formed in the cull plate 1 according to a fifth modification of the embodiment of the present invention. FIG. 9B is a cross-sectional view illustrating a shape of a gate hole 4′ which is provided in the resin injection path 3 (not illustrated) formed in a cull plate 1′ according to the related art.

As a result of measuring a necessary load to push off the cull 9 (not illustrated) left in the resin injection path 3 (not illustrated) provided with two gate holes 4 illustrated in FIG. 9A in the cull plate 1 according to the fifth modification using the extrusion tool 8 illustrated in FIGS. 4A and 4B, it has been found out that a load of 100 to 200 N is necessary. Similarly, it has been found out that a load of 30 to 40 N is sufficient to pull off the cull 9 (not illustrated) left in the resin injection path 3 (not illustrated) provided with two gate holes 4′ illustrated in FIG. 9B in the cull plate 1′ according to the related art. In this way, a holding force of the cull 9 caused by the gate hole 4 according to the fifth modification is larger than that of the cull 9 caused by the gate hole 4′ according to the related art. In other words, the gate hole 4 according to the fifth modification can be made such that the cull 9 hardly falls compared to the gate hole 4′ according to the related art. As illustrated in FIG. 9A, the gate hole 4 may have a step in a boundary between the upper portion 4a and the lower portion 4b.

Hitherto, in the above embodiment described above, the upper portion 4a of the gate hole 4 of the cull plate 1 used in the manufacturing method of the laminated core is formed as a tapered portion, and the lower portion 4b is formed as a straight pipe portion. Therefore, even when the cull 9 left in the resin injection path 3 is separated from the resin 11 filled in the magnet-insert hole 2a and thus the cull 9 in the gate hole 4 is displaced downward, the contact between the cull 9 and the inner surface of the gate hole 4 is maintained in the lower portion 4b. The cull 9 is prevented from falling down by a friction force applied in the cull 9 in the portion. In this way, according to the above embodiment, the falling of the cull 9 left in the gate hole 4 is minimized.

The above effect is also achieved even in a case where the shape of the gate hole 4 is formed as those illustrated in the first and second modifications. In other words, the shape of the gate hole 4 is not limited to those exemplified in the above embodiment. As illustrated in the third modification, the through hole provided with the tapered portion and the straight pipe portion is not limited to the gate hole 4. The through hole may be the blind hole 12. In other words, the above effect is achieved even when the blind hole 12 is provided with the tapered portion and the straight pipe portion. As illustrated in the fourth modification, the gate hole 4 is easily processed by dividing the cull plate 1 into the upper plate 1a and the lower plate 1b which are overlapped to form the cull plate 1. Therefore, the cull plate 1 is easily manufactured. After manufacturing the laminated core, the upper plate 1a and the lower plate 1b can be separated from each other and cleansed. Therefore, the cleansing of the cull plate 1 becomes easy. The assembly of the upper plate 1a and the lower plate 1b can be changed according to properties of the resin and processing conditions on the basis of a plurality of types of the upper plates 1a different in dimensions and shapes of the upper portion 4a and a plurality of types of the lower plates 1b different in dimensions and shapes of the lower portion 4b.

The technical scope of the present invention is not limited to the embodiment and the modifications. Various applications, modifications, or improvements may be made in a scope of the technical scope disclosed in claims of the present invention.

The shapes of the gate hole 4 and the blind hole 12 illustrated in the embodiment (that is, the shape of the through hole) are described as merely exemplary. The technical scope of the present invention is not limited to the shapes of the gate hole 4 and the blind hole 12 illustrated in the embodiment. The through hole is not limited to the configuration that the boundary between the tapered portion and the straight pipe portion has the same inner diameter. There may be a difference between the diameters of these two portions. For example, in the gate hole 4 illustrated in FIG. 2C, the inner diameter of the lower portion 4b may be larger than that of the lower end of the upper portion 4a.

As illustrated in FIGS. 2A and 2B, in a case where the plurality of gate holes 4 are provided in one resin injection path 3 (that is, a case where the plurality of through holes are provided in one resin injection path 3), the tapered portion and the straight pipe portion are not necessarily provided in the through hole. As long as the object of the present invention to minimize the falling of the cull 9 can be achieved, some through holes may be provided with the tapered portions and the other through holes may be provided with the straight pipe portion. At least one of the plurality of through holes may be provided with only the tapered portion or the straight pipe portion. In the resin injection path 3, the convex portion 7a is not an essential component. In other words, the resin injection path 3 may be not provided with the convex portion 7a.

The present invention is not limited to the configuration that two gate holes 4 (that is, the through holes) are formed in one resin injection path 3. One gate hole 4 may be formed in one resin injection path 3. Three or more gate holes 4 may be formed in one resin injection path 3. As described above, the through hole is not limited to the gate hole 4. The through hole may be the blind hole 12. Therefore, the plurality of gate holes 4 and blind holes 12 may be formed in one resin injection path 3.

The shape and the configuration of the laminated core body 2 illustrated in FIGS. 1A and 1B are given as merely exemplary for the laminated core which is manufactured using the cull plate 1. The technical scope of the present invention is not limited to the shape and the configuration of the laminated core body 2. The present invention is applied to the manufacturing of the laminated core which has various shapes, configurations, and usages.

The resin filling device 6 illustrated in FIGS. 3B and 3C is given as merely exemplary for a device used in the manufacturing of the laminated core. The technical scope of the present invention is not limited to the resin filling device 6 illustrated in the drawings.

The extrusion tool 8 illustrated in FIGS. 4A and 4B is given as merely exemplary for a part to eject the cull 9 from the cull plate 1. The technical scope of the present invention is not limited to the extrusion tool 8 illustrated in the drawings.

In FIGS. 8A and 8B, the tapered portion is formed in the upper portion 4a of the gate hole 4 formed in the upper plate 1a, the straight pipe portion is formed in the lower portion 4b of the gate hole 4 formed in the lower plate 1b. The upper plate 1a and the lower plate 1b are not limited to the above configuration. In a case where the cull plate 1 is provided with the gate hole 4 as illustrated in FIG. 6A, the straight pipe portion is formed in the upper plate 1a, and the tapered portion is formed in the lower plate 1b.

The type of resin filling the magnet-insert hole 2a is not limited. A thermoplastic resin may be used, or a thermosetting resin may be used.

The present invention may be preferably employed to a manufacturing method of the laminated core and a cull plate used in the method.

The following is a list of the reference numerals and signs corresponding to some elements of the embodiment in the drawings.
1, 1′: Cull plate
1a: Upper plate
1b: Lower plate
2: Laminated core body
2a: Magnet-insert hole
3: Resin injection path
4, 4′: Gate hole
4a: Upper portion
4b: Lower portion
4c: Intermediate part
5: Permanent magnet
6: Resin filling device
6a: Resin reservoir
6b: Upper die
6c: Lower die
7: Runner
7a: Convex portion
8: Extrusion tool
8a: Extrusion pin
9: Cull
10: Cracks
11: Resin
12: Blind hole

What is claimed is:

1. A manufacturing method of a laminated core, comprising:
holding a laminated core body mounted on a cull plate between an upper die and a lower die which are provided in a resin filling device;
injecting a resin to a magnet-insert hole of the laminated core body from a resin reservoir part provided in the lower die through the cull plate; then
ejecting the laminated core body and the cull plate from the resin filling device; and then
separating the cull plate from the laminated core body, wherein
the cull plate includes a through hole which forms at least a part of a flow path extended from the resin reservoir part to an upper surface of the cull plate, and
the through hole of the cull plate includes a tapered portion and a straight pipe portion being adjacent to the tapered portion, wherein the tapered portion has an inner diameter gradually decreasing toward the upper surface of the cull plate, and the straight pipe portion has a constant inner diameter in a height direction.

2. The manufacturing method of the laminated core according to claim 1, wherein the through hole is a gate hole from which the resin injected from the resin reservoir part to the magnet-insert hole is discharged toward the magnet-insert hole.

3. The manufacturing method of the laminated core according to claim 1, wherein the through hole is a blind hole in which a discharge port is closed by the laminated core body in a case where the laminated core body is mounted on the cull plate.

4. The manufacturing method of the laminated core according to claim 1, wherein the cull plate is formed by overlapping two plate members in a vertical direction, the tapered portion is formed in one of the plate members, and the straight pipe portion is formed in the other plate member.

5. The manufacturing method of the laminated core according to claim 1, wherein the cull plate includes a plurality of through holes, and
at least one of the plurality of through holes includes only a tapered portion having an inner diameter gradually decreasing toward the upper surface of the cull plate, or a straight pipe portion having a constant inner diameter in a height direction.

6. A cull plate which is held between a laminated core body and a lower die of a resin filling device in a process where the laminated core body with a permanent magnet inserted into a magnet-insert hole is held between an upper die and the lower die of the resin filling device to inject a resin from a resin reservoir part of the lower die to the magnet-insert hole, the cull plate comprising:
a through hole which forms at least a part of a flow path extended from the resin reservoir part to an upper surface of the cull plate, wherein
the through hole includes a tapered portion and a straight pipe portion being adjacent to the tapered portion, wherein the tapered portion has an inner diameter gradually decreasing toward the upper surface of the cull plate, and the straight pipe portion has a constant inner diameter in a height direction.

7. The cull plate according to claim 6, wherein the through hole is a gate hole from which the resin injected from the resin reservoir part to the magnet-insert hole is discharged toward the magnet-insert hole.

8. The cull plate according to claim 6, wherein the through hole is a blind hole in which a discharge port is closed by the laminated core body in a case where the laminated core body is mounted on the cull plate.

9. The cull plate according to claim 6, wherein the cull plate includes two plate members overlapped in a vertical direction, and the tapered portion is formed in one of the plate members, and the straight pipe portion is formed in the other plate member.

10. The cull plate according to claim 6, wherein the cull plate includes a plurality of through holes, and
at least one of the plurality of through holes includes only a tapered portion having an inner diameter gradually decreasing toward the upper surface of the cull plate, or a straight pipe portion having a constant inner diameter in a height direction.
